(19) United States
(12) Patent Application Publication
(10) Pub. No.: US 2024/0035306 A1
(43) Pub. Date: Feb. 1, 2024

(54) LOW-VOLTAGE ELECTROMECHANICAL STRIKE DEVICE

(71) Applicant: Omar Chibli, Dallas, TX (US)

(72) Inventor: Omar Chibli, Dallas, TX (US)

(21) Appl. No.: 18/361,359

(22) Filed: Jul. 28, 2023

Related U.S. Application Data
(60) Provisional application No. 63/369,852, filed on Jul. 29, 2022.

(51) Int. Cl. E05B 47/00

(52) U.S. Cl. CPC E05B 47/0001; E05B 47/0046; E05B 2047/0074; E05B 2047/0017

(57) ABSTRACT

A low-voltage, direct current apparatus for controlling a door, gate, or other access point to a structure or enclosed area. In some embodiments, the apparatus may comprise a housing, a face plate coupled to the housing, a strike plate coupled to the housing, and a keeper disposed between the face plate and the strike plate. The keeper may be rotatably coupled to the housing and may have a cavity configured to receive a latch coupled to a door or other access point. A motor may be disposed within the housing, and a shaft may be coupled to the motor. An actuator arm may be coupled to the shaft. The motor may be operable to rotate the shaft to move the actuator arm from a locked position to prevent movement of the keeper to an unlocked position to allow movement of the keeper.

### TECHNICAL FIELD

The invention set forth in the appended claims relates generally to systems and apparatuses for controlling access to a building, including, without limitation, electromechanical strike devices.

### BACKGROUND

Electronic access control devices, including electromechanical strikes, are in widespread use in commercial buildings and allow access to buildings or other areas to be restricted. For example, a door with an electromechanical strike generally remains locked from the outside, unless activated. If activated, an electromechanical strike can release a latch in a door, thereby unlocking the door. An electromechanical strike can be configured to automatically return to a locked position when a door is closed. A door with an electromechanical strike can additionally be configured to be opened from the inside by pressing a panic bar or other manual release device.

While the benefits of electromechanical strikes are widely known, improvements to such devices can significantly reduce cost of operation, including power and maintenance requirements.

### BRIEF SUMMARY

New and useful systems and apparatuses for controlling access to a building are set forth in the appended claims. Illustrative embodiments are also provided to enable a person skilled in the art to make and use the claimed subject matter.

For example, some embodiments may comprise a low-voltage, direct current apparatus for controlling a door, gate, or other access point to a structure or enclosed area. In some embodiments, the apparatus may comprise a housing, a face plate coupled to the housing, a strike plate coupled to the housing, and a keeper disposed between the face plate and the strike plate. The keeper may be rotatably coupled to the housing and may have a cavity configured to receive a latch coupled to a door or other access point. A motor may be disposed within the housing, and a shaft may be coupled to the motor. An actuator arm may be coupled to the shaft. The motor may be operable to rotate the shaft to move the actuator arm from a locked position in which the actuator arm prevents movement of the keeper to an unlocked position in which the actuator arm allows movement of the keeper.

In more particular embodiments, the motor may be disposed within the housing, substantially parallel to the keeper, and the actuator arm may be coupled to the shaft substantially orthogonal to the motor. For example, the actuator arm may have a proximal end and a distal end. The proximal end may be coupled to the shaft, and the distal end may be coupled to a locking arm, which can prevent movement of the keeper in the locked position. In some embodiments, the locking arm may be disposed in contact with or in close proximity to the keeper in the locked position. The motor can move the locking arm away from the keeper to the unlocked position, which can allow movement of the keeper.

Additionally, or alternatively, a first spring may be disposed within the housing to constrain movement of the motor parallel to the keeper, and a second spring may be disposed within the housing to constrain movement of the motor orthogonal to the keeper.

In other examples, some embodiments may comprise a housing and a keeper rotatably coupled to the housing. The keeper may have a cavity configured to receive a latch. A motor may be disposed within the housing, a shaft may be coupled to the motor, an actuator arm may be coupled to the shaft, and a locking arm may be coupled to the actuator arm. The motor can be operated to rotate the shaft, moving the actuator arm from a locked position to an unlocked position. The locking arm prevents movement of the keeper in the locked position, and the locking arm allows movement of the keeper in the unlocked position.

In yet other examples, an access control device may comprise a motor and a locking arm coupled to the motor. The motor can be operated on direct current at six volts or less to move the locking arm from a locked position to an unlocked position. Some embodiments may additionally comprise a keeper configured to receive a latch, and in the locked position, the locking arm can prevent rotation of the keeper. In the unlocked position, the locking arm allows rotation of the keeper to release the latch.

Additionally, or alternatively, some embodiments may further comprise an access control unit coupled to the motor and configured to determine if access should be allowed. If the access control unit determines that access should be allowed, the access control unit can deliver power to the motor.

Features, elements, and aspects described in the context of some embodiments may also be omitted, combined, or replaced by alternative features. Other features, objectives, advantages, and a preferred mode of making and using the claimed subject matter are described in greater detail below with reference to the accompanying drawings of illustrative embodiments.

### BRIEF DESCRIPTION OF THE DRAWINGS

The accompanying drawings illustrate some objectives, advantages, and a preferred mode of making and using some embodiments of the claimed subject matter. Like reference numbers represent like parts in the examples.

FIG. 1 is a schematic diagram of an example of a system for controlling access to a building.

FIG. 2 is an isometric view of an example of an electromechanical strike that may be associated with some embodiments of the system of FIG. 1.

FIG. 3 is schematic diagram of an example of the strike of FIG. 2.

FIG. 4 is an assembly view of a lock actuator that may be associated with some embodiments of the strike of FIG. 3.

FIG. 5 is a schematic diagram illustrating an example operation of the strike of FIG. 2.

### DESCRIPTION OF EXAMPLE EMBODIMENTS

The following description of example embodiments provides information that enables a person skilled in the art to make and use the subject matter set forth in the appended claims, but it may omit certain details already well known in the art. The following detailed description is, therefore, to be taken as illustrative and not limiting.

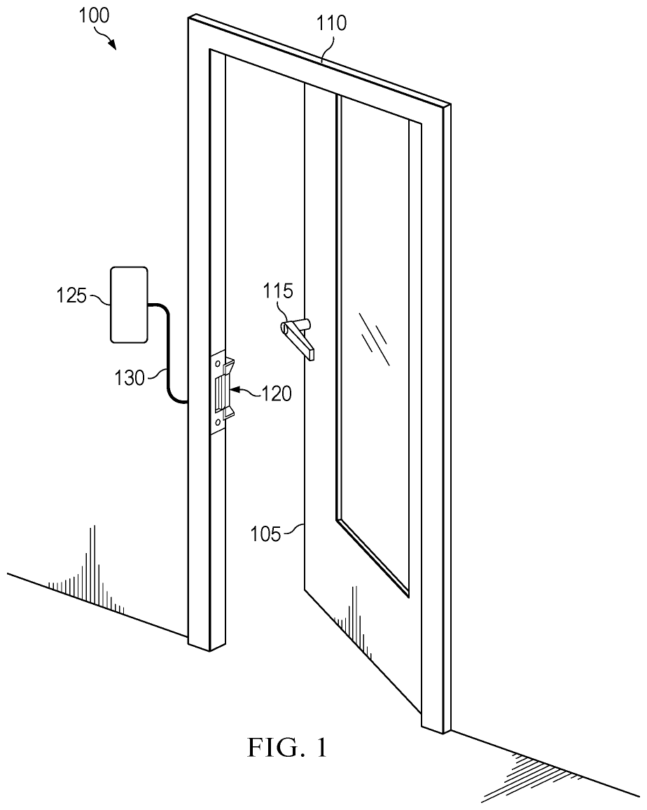

FIG. 1 is a schematic diagram of an example of a system 100 for controlling access to a structure or other area through an access point, such as a door 105. In the example of FIG. 1, the system 100 comprises a door frame 110, and the door 105 is configured to open to the interior of a structure. The system 100 may additionally comprise an exit device 115 and a strike 120. In the example of FIG. 1, the exit device 115 is a mortise latch. In other examples, the exit device 115 may be a push bar or other suitable device. The exit device 115 of FIG. 1 is coupled to the door 105, and the strike 120 is coupled to the door frame 110.

The system 100 may additionally have an access control unit 125 and a conductor 130. In some embodiments, the access control unit 125 may be configured to read or receive a signal from an identification unit (not shown), such as a radio frequency identifier (RFID), a magnetic stripe card, keypad, biometric scanner, or Bluetooth device. The access control unit 125 may be powered by relatively low-voltage, direct current source, such as a battery having a voltage in a range of about three (3) volts to about nine (9) volts, and preferably less than six (6) volts. The conductor 130 may electrically couple the access control unit 125 to the strike 120.

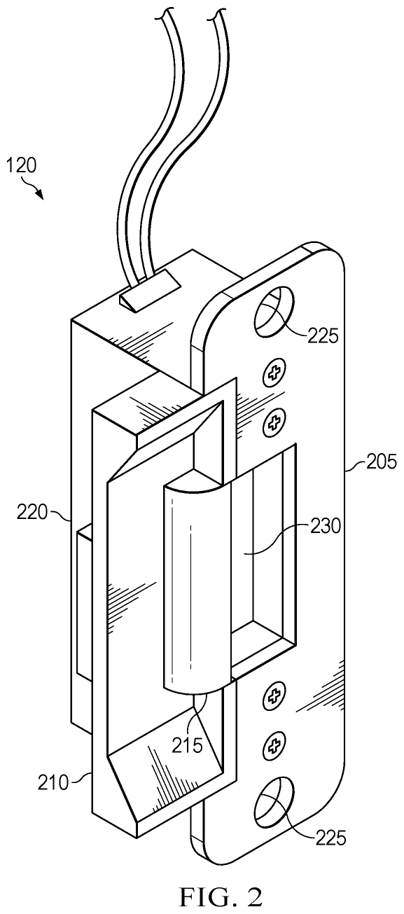

FIG. 2 is an isometric view of an example of the strike 120, illustrating additional details that may be associated with some embodiments. For example, the strike 120 of FIG. 2 generally comprises a face plate 205, a strike plate 210, a keeper 215, and a housing 220. The face plate 205 may have one or more mounting holes 225 in it through which screws can be inserted to fasten the strike 120 to a door frame, such as the door frame 110 of FIG. 1. The strike plate 210 can be coupled to the face plate 205, and the keeper 215 may be disposed between the face plate 205 and the strike plate 210. The strike plate 210 can provide a path for a latch to enter or exit the keeper 215. The strike plate 210 can also bridge a gap between the face plate 205 and the edge of the door frame 110. The face plate 205, the strike plate 210, or both, may be coupled to the housing 220. The keeper 215 of FIG. 2 comprises a cavity 230 into which a latch can project if a door is closed. For example, the exit device 115 of FIG. 1 may have a latch that is configured to project into the cavity 230 if the door 105 is closed. The keeper 215 of FIG. 2 is rotatably coupled to the housing 220. In some embodiments, for example, the keeper 215 may be coupled to a pivot pin (not shown), which can be coupled to the housing 220, and a return spring (not shown) can return the keeper 215 to its original position if rotated. For example, if the strike 120 is activated, a latch can pivot the keeper 215 outward if the strike 120, thereby releasing the latch and allowing the door 105 to be opened.

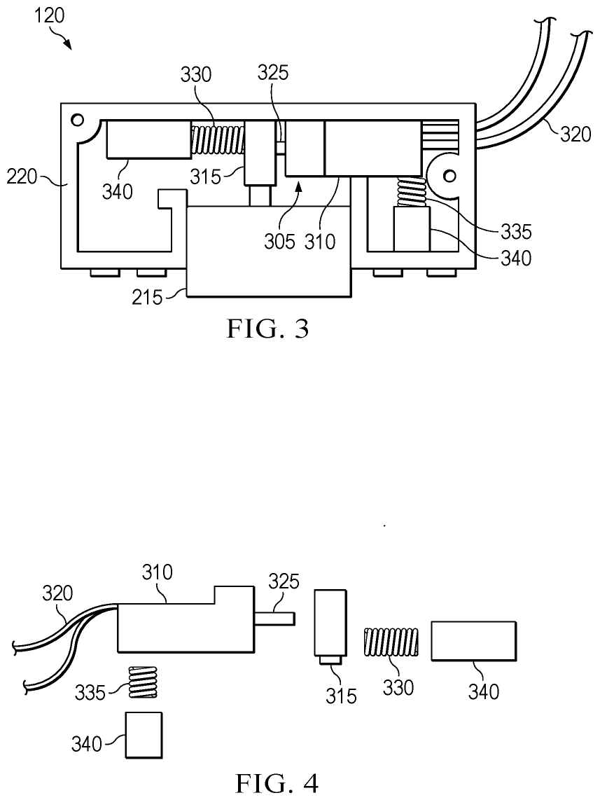

FIG. 3 is schematic diagram of an example of a portion of the strike 120 of FIG. 2, illustrating additional details that may be associated with some embodiment. The face plate 205 and the strike plate 210 of FIG. 2 have been removed in FIG. 3 to illustrate an interior portion of the housing 220. As shown in the example of FIG. 3, the strike 120 may comprise a lock actuator 305 disposed within the housing 220. The lock actuator 305 of FIG. 3 generally comprises a motor 310, an actuator arm 315, and conductors 320.

The motor 310 may be a direct current motor in some embodiments, and preferably operates at in a range of about three (3) volts to about six (6) volts. As shown in the example of FIG. 3, the motor may be disposed within the housing substantially parallel to the keeper 215.

The actuator arm 315 of FIG. 3 is coupled to a shaft 325 of the motor 310. In the example of FIG. 3, the actuator arm 315 is a cylinder having a proximal end coupled to the shaft 325. In other examples, the actuator arm 315 may comprise a plurality of arms, a separate linkage, or series of linkages. In the example of FIG. 3, the actuator arm 315 may be coupled to the shaft substantially orthogonal to the motor 310. The actuator arm 315 of FIG. 3 is illustrated in a locked position, in which a distal end of the actuator arm 315 is in contact with the keeper 215 to prevent rotation and other movement of the keeper 215.

The motor 310 may be coupled to the housing 220 in some embodiments. In the example of FIG. 3, the motor 310 is retained in position within the housing 220 by a first spring 330 and a second spring 335. In some embodiments, the first spring 330 and the second spring 335 may be partially disposed in a spring mount, such as the spring tubes 340 of FIG. 3. The first spring 330 may constrain movement of the motor 310 parallel to the keeper 215. The second spring 335 may constrain movement of the motor 310 orthogonal to the keeper 215.

The conductors 320 may be coupled to a source of direct current to provide power to the motor 310. For example, the conductors 320 may be coupled to the access control unit 125 of FIG. 1, or more particularly, to the conductor 130 or a battery in the access control unit 125.

FIG. 4 is an assembly view of the lock actuator 305 of FIG. 3, illustrating additional details that may be associated with some embodiments.

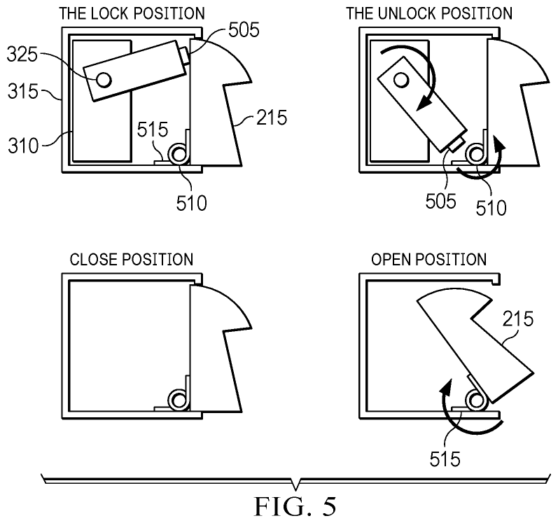

FIG. 5 is another schematic diagram of the strike 120 of FIG. 3, illustrating additional details that may be associated with the operation of the strike 120. As shown in the example of FIG. 5, a locking arm 505 may be coupled to the actuator arm 315 in some embodiments. In the example of FIG. 5, top left, the actuator arm 315 is illustrated in a locked position, in which the locking arm 505 is in contact with the keeper 215, thereby preventing rotation of the keeper 215. For example, if the door 105 is closed so that a latch associated with the exit device 115 is engaged to the keeper 215, the door 105 cannot be opened from the outside if the locking arm 505 prevents the keeper 215 from rotating out of the way of the latch. In operation, the motor 310 can be operated to control the rotation of the shaft 325, and thereby control the rotation of the actuator arm 315. For example, if the access control unit 125 determines that access should be allowed, the access control unit 125 can deliver power to the motor 310 through the conductors 320, which can cause the motor 310 to rotate the shaft 325 in a first direction. The rotation of the shaft 325 in this first direction can move the locking arm 505 in a first direction to an unlocked position, in which the locking arm 505 is not in contact with the keeper 215, as shown in the top right of FIG. 5, thereby allowing the keeper 215 to rotate if the door 105 is open from the outside. For example, the keeper 215 of FIG. 5 is coupled to a hinge 510, which can allow the keeper 215 to rotate if the locking arm 505 is in the unlocked position. A return spring 515 can return the keeper 215 to its original position after the door 105 is opened. If the polarity of the power to the motor 310 is reversed, the motor 310 can rotate the shaft 325 in a second direction, which can move the locking arm 505 in a second direction to return the locking arm 505 to the locked position.

In general, components of the system 100 may be coupled directly or indirectly. For example, the motor 310 may be directly coupled to the shaft 325 and may be indirectly coupled to the actuator arm 315 through the shaft 325. Similarly, the actuator arm 315 may be in direct contact with the keeper 215 or may indirectly contact the keeper 215 through the locking arm 505 and/or one or more intermediate linkages. Coupling may include fluid, mechanical, thermal, electrical, or chemical coupling (such as a chemical bond), or some combination of coupling in some contexts. For example, the motor 310 may be mechanically coupled to the shaft 325 and may be electrically coupled to the access control unit 125. In some embodiments, components may also be coupled by virtue of physical proximity, being integral to a single structure, or being formed from the same piece of material.

The systems, apparatuses, and methods described herein may provide significant advantages. Some embodiments may be particularly advantageous for reducing the cost of operating and maintaining doorway exit devices. For example, some embodiments can be installed without installing additional power sources or connecting to utility power sources, which can significantly reduce installation cost and allow installation in locations without utility power.

While shown in a few illustrative embodiments, a person having ordinary skill in the art will recognize that the systems, and apparatuses described herein are susceptible to various changes and modifications that fall within the scope of the appended claims. Moreover, descriptions of various alternatives using terms such as “or” do not require mutual exclusivity unless clearly required by the context, and the indefinite articles “a” or “an” do not limit the subject to a single instance unless clearly required by the context. Components may also be combined or eliminated in various configurations for purposes of sale, manufacture, assembly, or use. For example, in some configurations, the lock actuator 305 may be separated from or combined with other components in various ways for sale, manufacture, assembly, or use.

The claims may also encompass additional subject matter not specifically recited in detail. For example, certain features, elements, or aspects may be omitted from the claims if not necessary to distinguish the novel and inventive features from what is already known to a person having ordinary skill in the art. Features, elements, and aspects described in the context of some embodiments may also be omitted, combined, or replaced by alternative features serving the same, equivalent, or similar purpose without departing from the scope of the invention defined by the appended claims.

1. An apparatus for controlling a door, the apparatus comprising:
a housing;
a face plate coupled to the housing;
a strike plate coupled to the housing;
a keeper disposed between the face plate and the strike plate, the keeper rotatably coupled to the housing and having a cavity configured to receive a latch coupled to the door;
a motor disposed within the housing;
a shaft coupled to the motor; and
an actuator arm coupled to the shaft;
wherein the motor is operable to rotate the shaft to move the actuator arm from a locked position in which the actuator arm prevents movement of the keeper to an unlocked position in which the actuator arm allows movement of the keeper.

2. The apparatus of claim 1, wherein:
the motor is disposed within the housing substantially parallel to the keeper; and
the actuator arm is coupled to the shaft substantially orthogonal to the motor.

3. The apparatus of claim 1, wherein:
the motor is disposed within the housing substantially parallel to the keeper;
the actuator arm has a proximal end and a distal end, the proximal end coupled to the shaft and the distal end in contact with the keeper in the locked position; and
the motor is operable to rotate the distal end away from the keeper to the unlocked position.

4. The apparatus of claim 1, wherein:
a first spring constrains movement of the motor in a direction parallel to the keeper; and
a second spring constrains movement of the motor in a direction orthogonal to the keeper.

5. The apparatus of claim 1, wherein:
the motor is disposed within the housing substantially parallel to the keeper;
the actuator arm is coupled to the shaft substantially orthogonal to the motor;
a first spring constrains movement of the motor in a direction parallel to the keeper; and
a second spring constrains movement of the motor in a direction orthogonal to the keeper.

6. The apparatus of claim 1, wherein:
the motor is disposed within the housing substantially parallel to the keeper;
a first spring constrains movement of the motor in a direction parallel to the keeper;
a second spring constrains movement of the motor in a direction orthogonal to the keeper;
the actuator arm has a proximal end and a distal end, the proximal end coupled to the shaft and the distal end in contact with the keeper in the locked position; and
the motor is operable to rotate the distal end away from the keeper to the unlocked position.

7. The apparatus of claim 1, wherein the motor is operable on direct current at six volts or less.

8. The apparatus of claim 7, wherein the motor is operable on direct current in a range of about three volts to about six volts.

9. An apparatus for controlling an access point, the apparatus comprising:
a housing;
a keeper rotatably coupled to the housing and having a cavity configured to receive a latch;
a motor disposed within the housing;
a shaft coupled to the motor;
an actuator arm coupled to the shaft; and
a locking arm coupled to the actuator arm;
wherein the motor is operable to rotate the shaft to move the actuator arm from a locked position to an unlocked position, the locking arm prevents movement of the keeper in the locked position, and the locking arm allows movement of the keeper in the unlocked position.

10. The apparatus of claim 9, wherein the motor is operable on direct current at six volts or less.

11. The apparatus of claim 10, wherein the motor is operable on direct current in a range of about three volts to about six volts.

12. An access control device, comprising:
a motor; and
a locking arm coupled to the motor;
wherein the motor is operable on direct current at six volts or less to move the locking arm from a locked position to an unlocked position.

13. The access control device of claim 12, further comprising:
a keeper configured to receive a latch; and
wherein the locking arm prevents rotation of the keeper in the locked position, and the locking arm allows rotation of the keeper in the unlocked position to release the latch.

14. The access control device of claim 12, further comprising:
an access control unit coupled to the motor and configured to determine if access should be allowed; and
wherein if the access control unit determines that access should be allowed, the access control unit delivers power to the motor.

15. The access control device of claim 14, wherein the access control unit is configured to be operated on a direct current source.

16. The access control device of claim 15, wherein the direct current source is a battery having a voltage of nine volts or less.
